(19) United States
(12) Patent Application Publication
(10) Pub. No.: US 2008/0109846 A1
(43) Pub. Date: May 8, 2008

(54) SYSTEM AND METHOD FOR AUDIOVISUAL CONTENT PLAYBACK

(76) Inventors: C. Christian Ewertz, Bunkeflostrand (SE); Daniel Sandblom, Malmo (SE); Robert Najdenovski, Eslov (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/551,769

(22) Filed: Oct. 23, 2006

(51) Int. Cl. H04N 7/173; H04N 5/445; G06F 3/00; G06F 13/00; H04N 7/16

(52) U.S. Cl. 725/37; 725/100; 725/132; 725/62; 725/61; 725/86; 725/87; 725/38

(57) ABSTRACT

A method of playing back audiovisual content with an electronic device that has a keypad with a plurality of user operable keys includes associating respective items of audiovisual content with one or more of the keys. Operation of a key that has an associated item of audiovisual content is detected and, in response, the associated item of audiovisual content is played back.

### TECHNICAL FIELD OF THE INVENTION

The present invention relates generally to portable electronic devices and, more particularly, to a system and method for playing back audiovisual content that includes associating items of audiovisual content with keys of the electronic device.

### DESCRIPTION OF THE RELATED ART

Mobile and/or wireless electronic devices are becoming increasingly popular. For example, mobile telephones, portable media players and portable gaming devices are now in wide-spread use. In addition, the features associated with certain types of electronic devices have become increasingly diverse. To name a few examples, many electronic devices have cameras, text messaging capability, Internet browsing capability, electronic mail capability, video playback capability, audio playback capability, image display capability and handsfree headset interfaces.

Presently, portable electronic devices that are configured to play back audiovisual content allow a user to find a specific item of audiovisual content by navigating through a library of available audiovisual content items. For instance, songs that are available for playback from a music library may be displayable as a list, where each item is identified by name and/or artist. The music library may include songs that are stored by the electronic device in the form of audio files and/or songs that are available from a server for downloading. If the user is interested in playing back a specific item of audiovisual content, the user may search (e.g., scroll or browse) through the listed audiovisual content until the item of interest is found. Then the user may select that item for playback. Also, some electronic devices may allow the user to search for item of interest using search criteria, such as the name of a song or the name of an artist.

In other cases, a user may create a playlist of selected items of audiovisual content so that the selected items are played back in a specified order. To play back a specific item contained in the playlist, the user may skip tracks in a forward direction or a reverse direction. Alternatively, the user may have the ability to search the playlist to select and play back a specific item of interest from the playlist.

While these types of libraries and playlists may be searched for a specific item of interest, it may take some time to find the desired item.

### SUMMARY

To improve user interaction with audiovisual content, there is a need in the art for a system and method for audiovisual content playback that allows a user to quickly and simply access selected items of audiovisual content.

According to one aspect of the invention, a method of playing back audiovisual content with an electronic device that has a keypad with a plurality of user operable keys includes associating respective items of audiovisual content with one or more of the keys; detecting operation of a key that has an associated item of audiovisual content; and playing back the associated item of audiovisual content in response to the detection of the key operation.

According to one embodiment, the method further includes using an operational mode of the electronic device to distinguish whether operation of the key invokes playback of the associated item of audiovisual content or invokes a key-related function other than playback of the associated item of audiovisual content.

According to one embodiment of the method, the electronic device is a mobile telephone having a radio circuit for use in the establishment of a call.

According to one embodiment of the method, the keypad includes alphanumeric keys and the items of audiovisual content are respectively associated with one or more of the alphanumeric keys.

According to one embodiment of the method, an operational mode of the mobile telephone is used to distinguish whether operation of the key invokes playback of the associated item of audiovisual content or invokes a key-related function other than playback of the associated item of audiovisual content.

According to one embodiment of the method, the keypad includes dedicated keys for the playback of audiovisual content and the items of audiovisual content are respectively associated with one or more of the dedicated keys.

According to one embodiment of the method, the items of audiovisual content are associated with the keys by user action.

According to one embodiment of the method, the items of audiovisual content are associated with the keys by a service provider.

According to one embodiment of the method, the association of items of audiovisual content and the keys is based on a popularity ranking of the items of audiovisual content.

According to one embodiment of the method, the items of audiovisual content are sample segments of complete items of audiovisual content.

According to one embodiment of the method, the items of audiovisual content are selected from an audio file, an image file, a ring tone, a video file, a data stream and combinations thereof.

According to one embodiment of the method, the items of audiovisual content are stored locally by the electronic device.

According to one embodiment of the method, the items of audiovisual content are stored remotely from the electronic device.

According to another aspect of the invention, a program for playing back audiovisual content with an electronic device that has a keypad with a plurality of user operable keys is embodied on a machine readable medium. The program includes executable code to associate respective items of audiovisual content with one or more of the keys; detect operation of a key that has an associated item of audiovisual content; and playback the associated item of audiovisual content in response to the detection of the key operation.

According to one embodiment, the program further includes code to distinguish, based on an operational mode of the electronic device, whether operation of the key invokes playback of the associated item of audiovisual content or invokes a key-related function other than playback of the associated item of audiovisual content.

According to one embodiment of the program, the keypad includes alphanumeric keys and the items of audiovisual content are respectively associated with one or more of the alphanumeric keys.

According to another aspect of the invention, an electronic device includes a keypad with a plurality of user operable keys; and a control circuit that associates respective items of audiovisual content with one or more of the keys, detects operation of a key that has an associated item of audiovisual content, and plays back the associated item of audiovisual content in response to the detection of the key operation.

According to one embodiment of the electronic device, the control circuit distinguishes, based on an operation mode of the electronic device, whether operation of the key invokes playback of the associated item of audiovisual content or invokes a key-related function other than playback of the associated item of audiovisual content.

According to one embodiment of the electronic device, the electronic device is a mobile telephone having a radio circuit for use in the establishment of a call.

According to one embodiment of the electronic device, the keypad includes alphanumeric keys and the items of audiovisual content are respectively associated with one or more of the alphanumeric keys.

According to one embodiment of the electronic device, the keypad includes dedicated keys for the playback of audiovisual content and the items of audiovisual content are respectively associated with one or more of the dedicated keys.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic view of a mobile telephone as an exemplary electronic device in accordance with an embodiment of the present invention;

FIG. 2 is a schematic block diagram of the relevant portions of a mobile telephone constructed in accordance with an embodiment of the present invention;

FIG. 3 is a schematic diagram of a communications system in which a mobile telephone constructed in accordance with the present invention may operate;

FIG. 4 is a flow chart representing an exemplary method of playing back audiovisual content; and

FIG. 5 is a schematic view of another mobile telephone as an exemplary electronic device in accordance with an embodiment of the present invention.

### DETAILED DESCRIPTION OF EMBODIMENTS

Embodiments of the present invention will now be described with reference to the drawings, wherein like reference numerals are used to refer to like elements throughout. It will be understood that the figures are not necessarily to scale.

The interchangeable terms “electronic equipment” and “electronic device” include portable radio communication equipment. The term “portable radio communication equipment,” which herein after is referred to as a “mobile radio terminal,” includes all equipment such as mobile telephones, pagers, communicators, electronic organizers, personal digital assistants (PDAs), smartphones, portable communication apparatus or the like.

In the present application, the invention is described primarily in the context of a mobile telephone. However, it will be appreciated that the invention is not intended to be limited to a mobile telephone environment and may relate to any type of appropriate electronic equipment, examples of which include a media player, a gaming device and a computer.

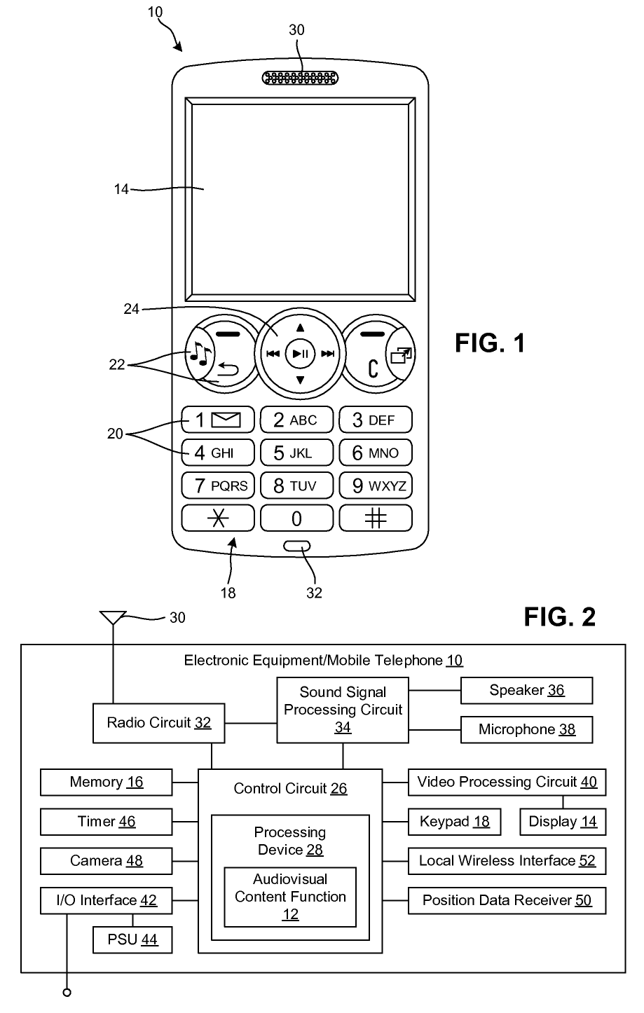

Referring initially to FIGS. 1 and 2, an electronic device 10 is shown. The electronic device 10 includes an audiovisual content function 12 that is configured to allow a user to quickly and simply access selected items of audiovisual content. The term “audiovisual content” broadly refers to any type of audio-based and/or video-based subject matter and may take the form of a stored file or streaming data. Stored files may include, for example, an image file (e.g., a photograph), a music file, a ring tone, a video file, and so forth and may be stored locally by a memory of the electronic device or remotely, such as by a server. Streaming data may relate to a service that delivers audio data and/or video data for consumption by the electronic device and may include, for example, mobile radio channels and/or mobile television channels. As used herein, the term “audiovisual content” expressly excludes call related operation of the electronic device 10 (e.g., generation of calling tones and/or the display of numbers or contact data on a display in connection with making or receiving a call) and expressly excludes electronic device operational functions unrelated to audio and/or video playback functions, such as menu navigation, manipulating electronic device settings, contact list management, message functions, photography functions, Internet usage functions, and so forth.

Additional details and operation of the audiovisual content function 12 will be described in greater detail below. The audiovisual content function 12 may be embodied as executable code that is resident in and executed by the electronic device 10. In one embodiment, the audiovisual content function 12 may be a program stored on a computer or machine readable medium. The audiovisual content function 12 may be a stand-alone software application or form a part of a software application that carries out additional tasks related to the electronic device 10.

The electronic device of the illustrated embodiment is a mobile telephone and will be referred to as the mobile telephone 10. The mobile telephone 10 is shown as having a “brick” or “block” form factor housing, but it will be appreciated that other type housings, such as a clamshell housing or a slide-type housing, may be utilized.

The mobile telephone 10 may include a display 14. The display 14 displays information to a user such as operating state, time, telephone numbers, contact information, various navigational menus, etc., which enable the user to utilize the various features of the mobile telephone 10. The display 14 also may be used to visually display content received by the mobile telephone 10 and/or retrieved from a memory 16 (FIG. 2) of the mobile telephone 10. The display 14 may be used to present images, video and other graphics to the user, such as photographs, mobile television content and video associated with games.

A keypad 18 provides for a variety of user input operations. The keypad 18 may include alphanumeric keys 20 for allowing entry of alphanumeric information such as telephone numbers, phone lists, contact information, notes, electronic mail messages, text messages, instant messages, etc. In addition, the keypad 18 may include function keys 22 such as a “call send” key for initiating or answering a call, and a “call end” key for ending or “hanging up” a call. The keypad 18 also may include a navigation input device 24 configured to allow the user to enter directional commands. Directional commands may be used to navigate through menus, audiovisual content libraries or playlists, to move a cursor and to interact with games, for example. The function keys 22 and/or the navigation input device 24 may have multiple uses. For instance, in the illustrated embodiment, the function keys 22 and navigation input device 24 are primarily labeled as having audiovisual content functions, but may also be used for menu navigation and select functions, telephone call functions and so forth. Also, various keys may be configured as softkeys to carryout functions associated with icons and/or text displayed on the display 14. Other keys associated with the mobile telephone may include a volume key, an audio mute key, an on/off power key, a web browser launch key, a camera key, etc. Also, key-like functionality may be embodied as a touch screen associated with the display 14.

The mobile telephone 10 includes call circuitry that enables the mobile telephone 10 to establish a call and/or exchange signals with a called/calling device, typically another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi, WiMax, etc. Another example includes a video enabled call that is established over a cellular or alternative network.

The mobile telephone 10 may be configured to transmit, receive and/or process data, such as text messages (e.g., colloquially referred to by some as “an SMS,” which stands for simple message service), electronic mail messages, multimedia messages (e.g., colloquially referred to by some as “an MMS,” which stands for multimedia message service), image files, video files, audio files, ring tones, streaming audio, streaming video, data feeds (including podcasts) and so forth. Processing such data may include storing the data in the memory 16, executing applications to allow user interaction with data, displaying video and/or image content associated with the data, outputting audio sounds associated with the data and so forth.

FIG. 2 represents a functional block diagram of the mobile telephone 10. For the sake of brevity, generally conventional features of the mobile telephone 10 will not be described in great detail herein. The mobile telephone 10 includes a primary control circuit 26 that is configured to carry out overall control of the functions and operations of the mobile telephone 10. The control circuit 26 may include a processing device 28, such as a CPU, microcontroller or microprocessor. The processing device 28 executes code stored in a memory (not shown) within the control circuit 26 and/or in a separate memory, such as the memory 16, in order to carry out operation of the mobile telephone 10. The memory 16 may be, for example, one or more of a buffer, a flash memory, a hard drive, a removable media, a volatile memory, a non-volatile memory or other suitable device.

In addition, the processing device 28 may execute code that implements the audiovisual content function 12. It will be apparent to a person having ordinary skill in the art of computer programming, and specifically in application programming for mobile telephones or other electronic devices, how to program a mobile telephone 10 to operate and carry out logical functions associated with the audiovisual content function 12. Accordingly, details as to specific programming code have been left out for the sake of brevity. Also, while the audiovisual content function 12 is executed by the processing device 22 in accordance with a preferred embodiment of the invention, such functionality could also be carried out via dedicated hardware, firmware, software, or combinations thereof, without departing from the scope of the invention.

Continuing to refer to FIGS. 1 and 2, the mobile telephone 10 includes an antenna 30 coupled to a radio circuit 32. The radio circuit 32 includes a radio frequency transmitter and receiver for transmitting and receiving signals via the antenna 30 as is conventional. The radio circuit 32 may be configured to operate in a mobile communications system and may be used to send and receive data and/or audiovisual content. Receiver types for interaction with a mobile radio network and/or broadcasting network include, but are not limited to, GSM, CDMA, WCDMA, GPRS, MBMS, WiFi, WiMax, DVB-H, ISDB-T, etc., as well as advanced versions of these standards.

The mobile telephone 10 further includes a sound signal processing circuit 34 for processing audio signals transmitted by and received from the radio circuit 32. Coupled to the sound processing circuit 34 are a speaker 36 and a microphone 38 that enable a user to listen and speak via the mobile telephone 10 as is conventional. The radio circuit 32 and sound processing circuit 34 are each coupled to the control circuit 26 so as to carry out overall operation. Audio data may be passed from the control circuit 26 to the sound signal processing circuit 34 for playback to the user. The audio data may include, for example, audio data from an audio file stored by the memory 16 and retrieved by the control circuit 26, or received audio data such as in the form of streaming audio data. The sound processing circuit 34 may include any appropriate buffers, decoders, amplifiers and so forth.

The display 14 may be coupled to the control circuit 26 by a video processing circuit 40 that converts video data to a video signal used to drive the display 14. The video processing circuit 40 may include any appropriate buffers, decoders, video data processors and so forth. The video data may be generated by the control circuit 26, retrieved from a video file that is stored in the memory 16, derived from an incoming video data stream received by the radio circuit 32 or obtained by any other suitable method.

The mobile telephone 10 may further include one or more I/O interface(s) 42. The I/O interface(s) 42 may be in the form of typical mobile telephone I/O interfaces and may include one or more electrical connectors. As is typical, the I/O interface(s) 42 may be used to couple the mobile telephone 10 to a battery charger to charge a battery of a power supply unit (PSU) 44 within the mobile telephone 10. In addition, or in the alternative, the I/O interface(s) 42 may serve to connect the mobile telephone 10 to a headset assembly (e.g., a personal handsfree (PHF) device) that has a wired interface with the mobile telephone 10. Further, the I/O interface(s) 42 may serve to connect the mobile telephone 10 to a personal computer or other device via a data cable for the exchange of data. The mobile telephone 10 may receive operating power via the I/O interface(s) 42 when connected to a vehicle power adapter or an electricity outlet power adapter.

The mobile telephone 10 may also include a timer 46 for carrying out timing functions. Such functions may include timing the durations of calls, generating the content of time and date stamps, etc. The mobile telephone 10 may include a camera 48 for taking digital pictures and/or movies. Image and/or video files corresponding to the pictures and/or movies may be stored in the memory 16. The mobile telephone 10 also may include a position data receiver 50, such as a global positioning system (GPS) receiver, Galileo satellite system receiver or the like.

The mobile telephone 10 also may include a local wireless interface 52, such as an infrared transceiver and/or an RF adaptor (e.g., a Bluetooth adapter), for establishing communication with an accessory, another mobile radio terminal, a computer or another device. For example, the local wireless interface 52 may operatively couple the mobile telephone 10 to a headset assembly (e.g., a PHF device) in an embodiment where the headset assembly has a corresponding wireless interface.

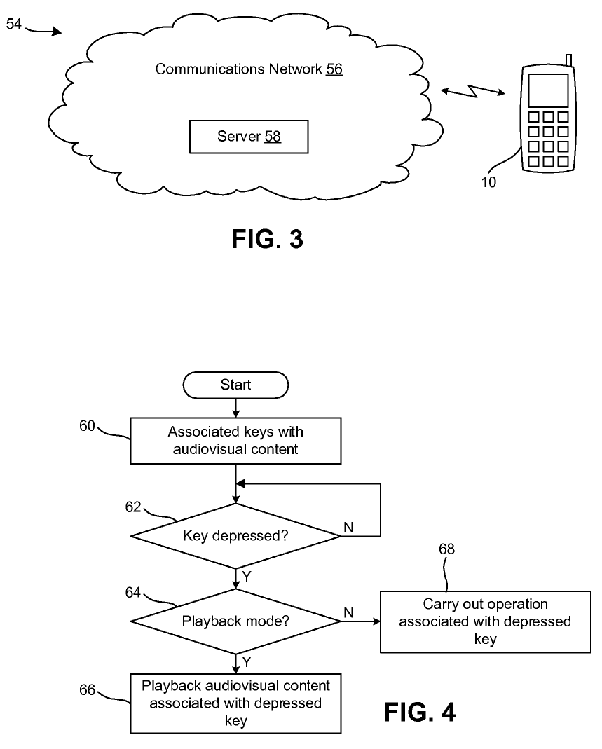

With additional reference to FIG. 3, the mobile telephone 10 may be configured to operate as part of a communications system 54. The system 54 may include a communications network 56 having a server 58 (or servers) for managing calls placed by and destined to the mobile telephone 10, transmitting data to the mobile telephone 10 and carrying out any other support functions. The server 58 communicates with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 56 may support the communications activity of multiple mobile telephones 10 and other types of end user devices. As will be appreciated, the server 58 may be configured as a typical computer system used to carry out server functions and may include a processor configured to execute software containing logical instructions that embody the functions of the server 58 and a memory to store such software.

With additional reference to FIG. 4, illustrated are logical operations to implement an exemplary method of accessing a selected item of audiovisual content. The exemplary method may be carried out by executing an embodiment of the audiovisual content function 12, for example. Thus, the flow chart of FIG. 4 may be thought of as depicting steps of a method carried out by the mobile telephone 10. Although FIG. 4 shows a specific order of executing functional logic blocks, the order of executing the blocks may be changed relative to the order shown. Also, two or more blocks shown in succession may be executed concurrently or with partial concurrence. Certain blocks also may be omitted. In addition, any number of functions, logical operations, commands, state variables, semaphores or messages may be added to the logical flow for purposes of enhanced utility, accounting, performance, measurement, troubleshooting, and the like. It is understood that all such variations are within the scope of the present invention.

The logical flow for the audiovisual content function 12 may begin in block 60 where items of audiovisual content are associated with keys of the keypad 18. For example, the user may assign a song from a music library to each of the alphanumeric keys 20 that are associated with the numbers zero through nine. In this manner, ten songs may each have an associated keypad key 20. The logical association of a key 20 to a song or other item of audiovisual content may be made by using a menu-driven graphical user interface. In one embodiment, a database, look-up table or other data structure may be used to store the association in the memory 16. In particular, the key/content association storage mechanism may store a file name and/or data storage path for the specified audiovisual content with an identifier for the selected key 20. It will be appreciated that keypad keys (e.g., the function keys 22 and/or the navigation input device 24) may be associated with an item of audiovisual content in addition to or instead of the alphanumeric keys 20.

In one embodiment, the audiovisual content associated with a key 20 may be a song that is stored as an audio file by the memory 16 of the mobile telephone 10. However, the audiovisual content function 12 may be adapted to associate any type of audiovisual content with keys 20, 22 and/or 24 of the keypad 18. For instance, the associated content may be another type of file stored by the mobile telephone 10, such as an image file, a ring tone, a sound effect stored as an audio file, a video file and so on. In other embodiments, the keys may be associated with audiovisual content that is stored remotely from the mobile telephone 10 and that may be downloaded, pushed or streamed to the mobile telephone 10. For instance, the audiovisual content associated with a key may be a channel of a mobile radio service or a mobile television service, or may be a file that is push delivered, downloaded or otherwise transferred upon the occurrence of a triggering event.

In the foregoing examples, the audiovisual content that is associated with a particular key is selected by the user. In other embodiments, the audiovisual content may be associated using a predetermined approach implemented by the audiovisual content function 12 or a service hosted remotely from the mobile telephone 10. For instance, the audiovisual content function 12 may be configured to associate the ten songs that the user listens to most with the keys 20 in ranked order with the “one” key 20 corresponding to the most frequently accessed song and the “zero” key 20 corresponding to the tenth most frequently accessed song.

As another example, the server 58 may be configured to push or otherwise transfer associations to the mobile telephone 10 so as to associate songs on a “pop-chart” or other music popularity ranking with the keys 20. Alternatively, the associations may be downloaded on a periodic basis or in response to user action. The music ranking may correspond to a music category selected by the user. The associations may be updated when a new popularity ranking is released. In one embodiment, the corresponding songs also may be downloaded to the mobile telephone 10. Alternatively, the songs may be accessed on an on-demand basis. In either case, the number of times the song may be played back may be limited based on the terms of a subscription that the user has with a service provider. In one embodiment, samples of the songs may be associated with the keys 20 and, after listening to a sample, the user may be offered the opportunity to purchase the song for a predetermined number of playbacks or for unlimited playback. The association of keys 20 to songs based on popularity may be adapted to other types of audiovisual content. For instance, the most popular images or video files viewed at a particular website may be associated with the keys 20.

Following block 60, the logical flow may proceed to block 62 where a determination may be made as to whether one of the keys 20 that is associated with an item of audiovisual content has been depressed. Sensing or detecting of a key depression may be made by using the control circuit 26 to monitor signals from the keypad 18 that correspond to key depressions. If a key 20 has not been depressed, the logical flow may wait until a key 20 is depressed. Upon a positive determination in block 62, the logical flow may proceed to block 64.

In block 64 a determination may be made as to whether the mobile telephone 10 is in a mode to play back the audiovisual content that is associated with the depressed key 20. For instance, the situational context and/or the manner in which the mobile telephone 10 is used may be indicative of whether the user intends to play back the associated content or use the key 20 for entry of an alphanumeric character (e.g., number, letter or symbol). For instance, if the user is composing a text or electronic mail message, dialing a telephone number, populating a contact list entry and so forth, a conclusion may be drawn that the key 20 is being used for alphanumeric character entry and a negative determination may be made in block 64. On the other hand, if the mobile telephone 10 has been placed in an audiovisual content playback mode and a key 20 is pressed, a conclusion may be made that the user is interested in accessing the audiovisual content that is associated with the depressed key 20 and a positive determination may be made in block 64. As another example, the user may want to play a sound effect during a telephone call (e.g., to play a call answer greeting, to indicate a desire to end the call, or to add a dramatic flair to the conversation). To distinguish the desire to play back a sound effect or other item of audiovisual content during the call from the desire to use the key 20 to navigate through an automated menu using dial tone multi frequency (DTMF) signals, an additional user action may be involved to specify audiovisual content playback. For instance, the user may set a menu option to have the mobile telephone 10 play back audiovisual content instead of generating a DTMF signal when a key 20 is depressed during a telephone call. As another example, to invoke playback of the associated audiovisual content during a telephone call, during other operational modes of the mobile telephone 10 and/or when the mobile telephone 10 is idle, the key 20 may be depressed in conjunction with the depression of another key (e.g., one of the function keys 22).

If a positive determination is made in block 64, the logical flow may proceed to block 66 where the audiovisual content associated with the depressed key 20 is played back. For example, if the content corresponds to a stored audio file, the audio file may be retrieved and audibly output using the speaker 36 or an operatively interfaced headset. If the content corresponds to an image, the image may be displayed on the display 14. If the content corresponds to a video file, a video component may be displayed on the display 14 and an audio component may be audibly output. If the audiovisual content corresponds to a mobile radio station or a mobile television station, the radio circuit 32 may be tuned to the appropriate station or synchronized with an appropriate time slice of an available data stream. Adaptation of the audiovisual content function 12 to playback other forms of audiovisual content will be apparent to one of ordinary skill in the art.

If a negative determination is made in block 64, the logical flow may proceed to block 68. In block 68 the mobile telephone 10 may carry out an operation associated with the depressed key 20. The operation may be determined as a function of an operational mode of the mobile telephone 10 or the situational context at the time that the key 20 is depressed. For instance, the manner in which the mobile telephone 10 is being used may indicate that the depression of the key 20 corresponds to entry of a telephone number digit, entry of an alphanumeric character into a text field or a command to recall a previously stored speed dial telephone number.

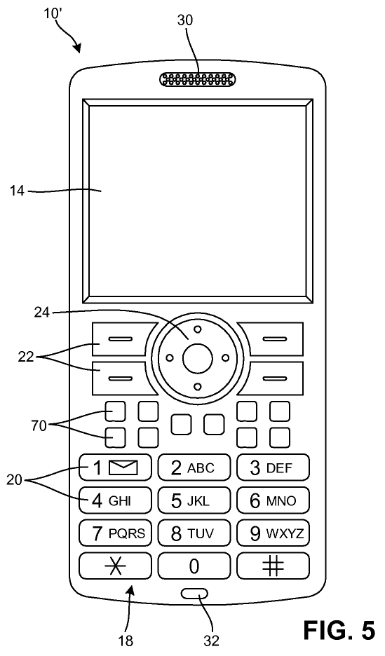

With additional reference to FIG. 5, another mobile telephone 10′ is illustrated. The mobile telephone 10′ is similar to the mobile telephone 10 except that the mobile telephone 10′ has the added feature of dedicated audiovisual content playback keys 70. The dedicated audiovisual content playback keys 70 may be added as part of the keypad 18, which also may include the alphanumeric keys 20, the function keys 22 and/or the navigation input device 24 as described above. In one embodiment, the dedicated audiovisual content playback keys 70 may be associated with items of audiovisual content in the manner that the alphanumeric keys 20, the functions keys 22 and/or the navigation input device 24 are associated with items of audiovisual content in the embodiments described above. When one of the playback keys 70 is depressed, the corresponding item of audiovisual content may be played back.

As will be appreciated, various methods and systems for playing back audiovisual content in a manner that allows a user to quickly and simply access selected items of audiovisual content have been described. The methods and systems allow the user to directly select an item of audiovisual content for immediate playback without navigating through a list and/or skipping through tracks. Although these methods and systems have been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. A method of playing back audiovisual content with an electronic device that has a keypad with a plurality of user operable keys, comprising:
associating respective items of audiovisual content with one or more of the keys;
detecting operation of a key that has an associated item of audiovisual content; and
playing back the associated item of audiovisual content in response to the detection of the key operation.

2. The method of claim 1, further comprising using an operational mode of the electronic device to distinguish whether operation of the key invokes playback of the associated item of audiovisual content or invokes a key-related function other than playback of the associated item of audiovisual content.

3. The method of claim 1, wherein the electronic device is a mobile telephone having a radio circuit for use in the establishment of a call.

4. The method of claim 3, wherein the keypad includes alphanumeric keys and the items of audiovisual content are respectively associated with one or more of the alphanumeric keys.

5. The method of claim 4, wherein an operational mode of the mobile telephone is used to distinguish whether operation of the key invokes playback of the associated item of audiovisual content or invokes a key-related function other than playback of the associated item of audiovisual content.

6. The method of claim 3, wherein the keypad includes dedicated keys for the playback of audiovisual content and the items of audiovisual content are respectively associated with one or more of the dedicated keys.

7. The method of claim 1, wherein the items of audiovisual content are associated with the keys by user action.

8. The method of claim 1, wherein the items of audiovisual content are associated with the keys by a service provider.

9. The method of claim 8, wherein the association of items of audiovisual content and the keys is based on a popularity ranking of the items of audiovisual content.

10. The method of claim 8, wherein the items of audiovisual content are sample segments of complete items of audiovisual content.

11. The method of claim 1, wherein the keypad includes dedicated keys for the playback of audiovisual content and the items of audiovisual content are respectively associated with one or more of the dedicated keys.

12. The method of claim 1, wherein the items of audiovisual content are selected from an audio file, an image file, a ring tone, a video file, a data stream and combinations thereof.

13. The method of claim 1, wherein the items of audiovisual content are stored locally by the electronic device.

14. The method of claim 1, wherein the items of audiovisual content are stored remotely from the electronic device.

15. A program embodied on a machine readable medium for playing back audiovisual content with an electronic device, the electronic device having a keypad with a plurality of user operable keys, the program comprising executable code to:
associate respective items of audiovisual content with one or more of the keys;
detect operation of a key that has an associated item of audiovisual content; and
playback the associated item of audiovisual content in response to the detection of the key operation.

16. The program of claim 15, further comprising code to distinguish, based on an operational mode of the electronic device, whether operation of the key invokes playback of the associated item of audiovisual content or invokes a key-related function other than playback of the associated item of audiovisual content.

17. The program of claim 15, wherein the keypad includes alphanumeric keys and the items of audiovisual content are respectively associated with one or more of the alphanumeric keys.

18. An electronic device, comprising:
a keypad with a plurality of user operable keys; and
a control circuit that associates respective items of audiovisual content with one or more of the keys, detects operation of a key that has an associated item of audiovisual content, and plays back the associated item of audiovisual content in response to the detection of the key operation.

19. The electronic device of claim 18, wherein the control circuit distinguishes, based on an operation mode of the electronic device, whether operation of the key invokes playback of the associated item of audiovisual content or invokes a key-related function other than playback of the associated item of audiovisual content.

20. The electronic device of claim 18, wherein the electronic device is a mobile telephone having a radio circuit for use in the establishment of a call.

21. The electronic device of claim 20, wherein the keypad includes alphanumeric keys and the items of audiovisual content are respectively associated with one or more of the alphanumeric keys.

22. The electronic device of claim 20, wherein the keypad includes dedicated keys for the playback of audiovisual content and the items of audiovisual content are respectively associated with one or more of the dedicated keys.
